(19) United States
(12) Patent Application Publication
(10) Pub. No.: US 2025/0241218 A1
(43) Pub. Date: Jul. 31, 2025

(54) IMPLEMENTS FOR DISPLACING GROUND MATERIAL

(71) Applicant: CLAUSSEN TECHNOLOGY, LLC, Benson, MN (US)

(72) Inventors: Steven W. CLAUSSEN, Glenwood, MN (US); Jereme ASCHEMAN, Benson, MN (US)

(21) Appl. No.: 19/039,517

(22) Filed: Jan. 28, 2025

Related U.S. Application Data
(60) Provisional application No. 63/626,429, filed on Jan. 29, 2024.

(51) Int. Cl. A01B 39/14; A01B 13/02; A01B 15/16; A01B 27/00; A01B 33/10; A01B 33/16; A01B 39/08; A01B 49/02; A01B 49/06; A01C 23/00

(52) U.S. Cl. CPC A01B 39/14; A01B 13/025; A01B 15/16; A01B 27/005; A01B 33/103; A01B 39/08; A01B 49/02; A01B 49/06; A01B 33/16; A01C 23/00

(57) ABSTRACT

Implement apparatus may be configured to displace ground material. For example, an implement may include an extension member coupled to a roller apparatus. The extension member may be coupled to a mounting apparatus configured to mount each of a crumbler, a hipper, a bermer, a bermer, crumbler combination apparatus, or a chopping apparatus.

This application claims the benefit of 63/626,429, filed Jan. 29, 2024, the disclosure of which is incorporated by reference herein in its entirety.

The present disclosure relates to implements and implement systems for use in displacing ground material. The implements may include a roller apparatus configured to engage a ground surface and form a plurality of reservoirs in the ground surface, one or more ground working elements such as, for example, a crumbler or crumbling apparatus, a bermer or berming apparatus, a hipper or hipping apparatus, a liquid material dropper, and/or a chopper or chopping apparatus.

Water distributed through irrigation systems or from rain may be unevenly dispersed over an agricultural field due to runoff and further may be subject to evaporation. For example, a sloped or angled ground surface may also contribute to water runoff where water may run from higher areas of a field to lower areas of the field. Additionally, water exposed on the top of the ground surface may be subject to evaporation.

### SUMMARY

The present disclosure describes exemplary implements, implement systems, and methods for use in conditioning soil.

In one or more embodiments, the present disclosure provides an implement apparatus couplable to a vehicle configured to traverse a ground surface. The implement apparatus includes an extension member couplable to the vehicle and extending between a proximal end portion and a distal end portion and a roller apparatus coupled to the extension member. The implement apparatus also includes a ground working element, as well as a mounting apparatus movably coupled to the distal end portion of the extension member. The mounting apparatus is configured to move between a first configuration to position the ground working element to engage the ground surface when the vehicle traverses the ground surface and a second configuration to position the ground working element so as to not engage the ground surface when the vehicle traverses the ground surface.

In one or more embodiments, the present disclosure provides an implement apparatus couplable to a vehicle configured to traverse a ground surface. The implement apparatus includes an extension member couplable to the vehicle and extending between a proximal end portion and a distal end portion. The implement apparatus also includes a roller apparatus coupled to the extension member and configured to engage the ground surface when the vehicle traverses the ground surface. The roller apparatus includes a cylindrical portion defining an outer cylindrical surface and lying along a roller axis configured to rotate as the vehicle traverses the ground surface. The roller apparatus also includes a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface. The roller apparatus further includes a ground working element and a mounting apparatus movably coupled to the distal end portion of the extension member and configured to move between a first configuration to position the ground working element to engage the ground surface when the vehicle traverses the ground surface and a second configuration to position the ground working element so as to not engage the ground surface when the vehicle traverses the ground surface.

In one or more embodiments, the present disclosure provides an implement apparatus couplable to a vehicle configured to traverse a ground surface between a first crop row and a second crop row immediately adjacent to the first crop row. The implement apparatus includes an extension member couplable to the vehicle and extending between a proximal end portion and a distal end portion. The implement apparatus further includes a roller apparatus coupled to the extension member and configured to engage the ground surface between the first crop row and the second crop row when the vehicle traverses the ground surface. The roller apparatus includes a cylindrical portion defining an outer cylindrical surface and lying along a roller axis configured to rotate as the vehicle traverses the ground surface. The roller apparatus also includes a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface. The extension member is couplable to one or more of at least three different ground working elements, each of the at least three different ground working elements configured to engage the ground surface and work the ground surface in a different way than each other between the first crop row and the second crop row when the vehicle traverses the ground surface.

In one or more embodiments, the present disclosure provides an implement apparatus couplable to a vehicle configured to traverse a ground surface between a first crop row and a second crop row immediately adjacent to the first crop row. The implement apparatus includes: an extension member couplable to the vehicle and extending between a proximal end portion and a distal end portion. The implement apparatus further includes a roller apparatus coupled to the extension member and configured to engage the ground surface between the first crop row and the second crop row when the vehicle traverses the ground surface. The roller apparatus includes a cylindrical portion defining an outer cylindrical surface and lying along a roller axis configured to rotate as the vehicle traverses the ground surface. The roller apparatus also includes a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface. The extension member is couplable to at least one ground working element configured to engage the ground surface and work the ground surface between the first crop row and the second crop row when the vehicle traverses the ground surface, and wherein the implement apparatus is configured to be positioned between the first crop row and the second crop row.

In one or more embodiments, the present disclosure provides an implement apparatus couplable to a vehicle configured to traverse a ground surface, wherein the implement apparatus includes an extension member couplable to the vehicle and extending between a proximal end portion and a distal end portion. The implement apparatus further includes roller apparatus rotatably coupled to the extension member and configured to engage the ground surface when the vehicle traverses the ground surface. The roller apparatus includes a cylindrical portion defining an outer cylindrical surface and lying along a roller axis configured to rotate as the vehicle traverses the ground surface. The roller apparatus also includes a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface. The implement apparatus further includes a chopping apparatus coupled to the extension member, wherein the chopping apparatus includes a plurality of cutting blades adapted to rotate relative to the ground surface and oriented such that each of the cutting blades are perpendicular to a direction the vehicle is traversing along the ground surface.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 is a perspective view of a vehicle towing a plurality of implement apparatuses.

FIG. 2 is a top view of the vehicle in FIG. 1 towing a plurality of implement apparatuses.

FIG. 3 is a perspective view of an implement apparatus including a mounting apparatus.

FIG. 4 is a side view of an implement apparatus of FIG. 3.

FIG. 5 is a side view of an implement apparatus of FIG. 3 in another configuration.

FIG. 6 is a perspective view of an implement apparatus including a bermer.

FIG. 7 is a top view of the implement apparatus of FIG. 6.

FIG. 8 is a perspective view of an implement apparatus including a hipper.

FIG. 9 is a top view of the implement apparatus of FIG. 8.

FIG. 10 is a perspective view of an implement apparatus including a crumbler.

FIG. 11 is a top view of the implement apparatus of FIG. 10.

FIG. 12 is a perspective view of an implement apparatus including a bermer and crumbler combination apparatus.

FIG. 13 is a top view of the implement apparatus of FIG. 12.

FIG. 14 is a perspective view of an implement apparatus including a dropper configured to dispense fertilizer to two crops rows.

FIG. 15 is a top view of the implement apparatus of FIG. 14.

FIG. 16 is a perspective view of an implement apparatus including a dropper configured to dispense fertilizer between two crops rows.

FIG. 17 is a perspective view of an implement apparatus including a chopping apparatus when the chopping apparatus is in the working configuration.

FIG. 18A is a perspective view of the cutting blades and rotatable portion of the chopping apparatus of FIG. 17.

FIG. 18B is a side view of the cutting blades and rotatable portion of the chopping apparatus of FIG. 17.

FIG. 19 is a side view of the implement apparatus of FIG. 17 when in the working configuration.

FIG. 20 is a side view of the implement apparatus of FIG. 17 when in the storage configuration.

FIG. 21 is a perspective view of an implement apparatus including a chopping apparatus positioned rearward.

### DETAILED DESCRIPTION

In the following detailed description of illustrative embodiments, reference is made to the accompanying figures of the drawings which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

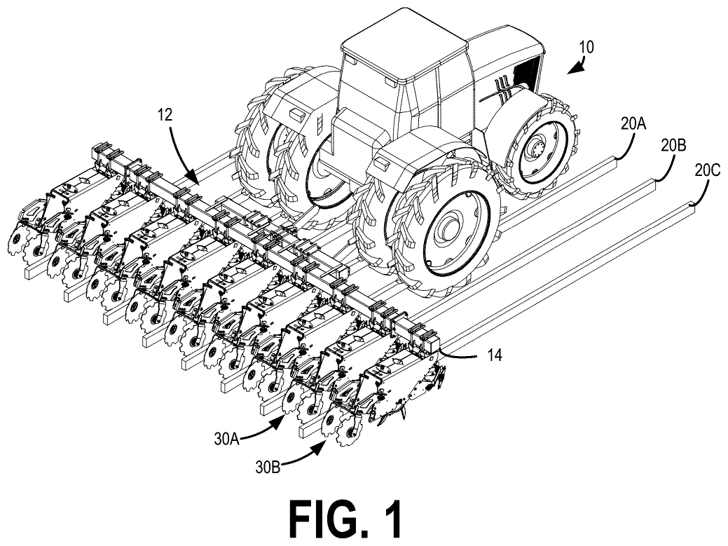

Exemplary apparatus, systems, and methods shall be described with reference to FIGS. 1-21. It will be apparent to one skilled in the art that elements from one embodiment may be used in combination with elements of the other embodiments, and that the possible embodiments of such apparatus, systems, and methods using combinations of features set forth herein is not limited to the specific embodiments shown in the figures and/or described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes and/or sizes, or types of elements, may be advantageous over others.

Illustrative implements, implement systems, and methods described herein may be configured to engage a ground surface to crumble, berm, hip, till, aerate, chop, and/or form a plurality of reservoirs therein. The illustrative implements may include a chopping apparatus, roller apparatus, and the roller apparatus may include a plurality of ground displacing elements shaped, sized, and/or configured in many different ways which will be described herein with respect to FIGS. 1-21. As used herein, a “reservoir” may be defined as an indentation, recess, and/or cavity formed within a ground surface configured such that fluid (e.g., water) or material may be collected and/or held therein.

FIG. 1 depicts an exemplary vehicle 10 towing a plurality of implement apparatuses including a first implement apparatus 30A and a second implement apparatus 30B. The vehicle 10 can be a tractor. The vehicle 10 can traverse a field including a plurality of crop rows, such as a first crop row 20A, a second crop row 20B, and a third crop row 20C. The plurality of crop rows can include row crops such as corn, soybeans, cotton, wheat, potatoes, sugar beets, sunflowers, etc. The vehicle 10 can include and/or be coupled to a towing apparatus 12 that allows the vehicle to tow the plurality of implement apparatuses. In some configurations, the towing apparatus 12 can include a crossmember 14 to which each implement apparatus included in the plurality of implement apparatuses can be mounted.

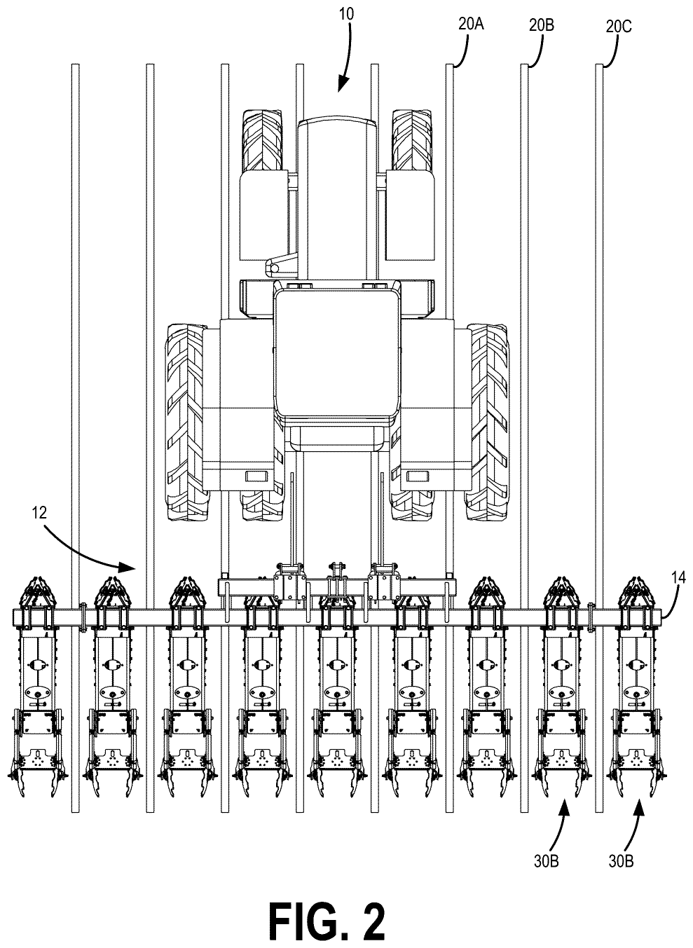

As shown in FIG. 1 as well as FIG. 2, each implement apparatus included in the plurality of implement apparatuses can be positioned between two immediately adjacent crop rows included in the plurality of crop rows. For example, the first implement apparatus 30A can be positioned between the first crop row 20A and the second crop row 20B. Furthermore, the second implement apparatus 30B can be positioned between the second crop row 20B and the third crop row 20C. As will be discussed further below, the placement of the implement apparatuses between crop rows can allow each implement apparatus to provide multiple ground working functions across various portions of the growing season. The implement apparatus (e.g., the first implement apparatus 30A) can provide multiple functionalities that other implements that straddle a single crop row cannot provide.

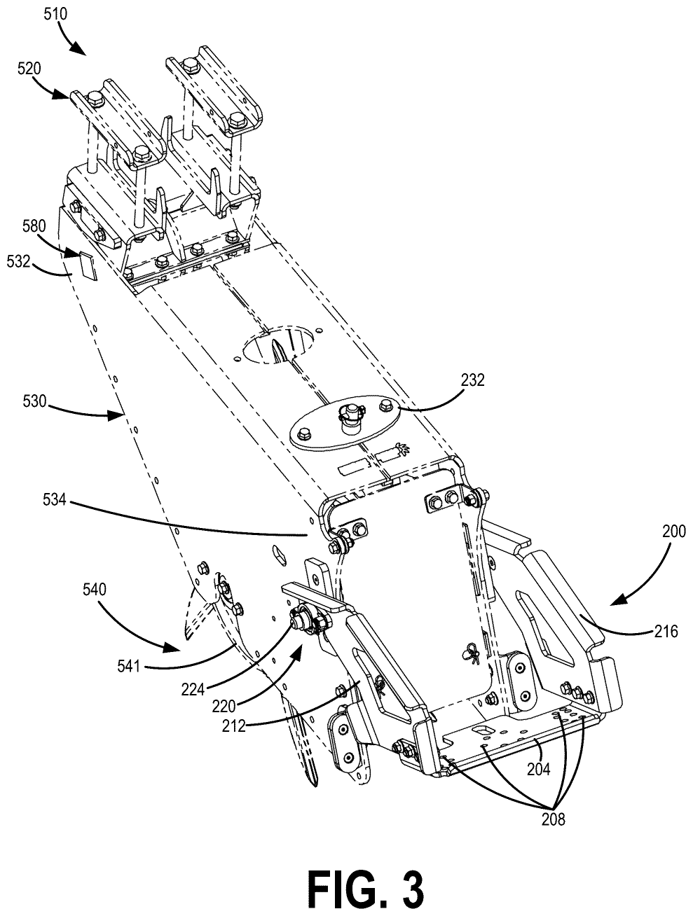

An illustrative implement 510 is shown in FIGS. 3-5. The implement 510 may include a mount portion 520, an extension member 530, and a roller apparatus 540. The mount portion 520 may be configured to be coupled to a vehicle (e.g., the vehicle 10 in FIG. 1), such as a tractor, to couple the exemplary implement 510 to the vehicle. The vehicle may be used to pull the implement between rows of vegetation or crops to form a plurality of reservoirs or to loosen the ground (e.g., aerate, till, etc.) between the rows using the implement 510. To provide the coupling between the implement 510 and a vehicle, the mount portion 520 may include one or more mounting brackets configured to be coupled, or attached, to a portion of a vehicle. As shown, the mounting brackets may define a plurality of apertures, or openings, through which fasteners, such as bolts, may extend to couple the brackets to the vehicle. Further, other features of the implement 510 may be included as described in U.S. Pat. No. 9,674,996 entitled “Implement for Displacing Ground Material,” which is herein incorporated by reference. As such, it is to be understood that one or more such features and/or portions therein may be used interchangeably between each and every embodiment described herein.

The mount portion 520 may not be directly coupled to a vehicle, and instead, may be coupled to an apparatus that is coupled to the vehicle. For example, the mount portion 520 may be coupled to a frame apparatus, such as, e.g., a beam, or other support member, which may be coupled to the vehicle. In one or more embodiments, an exemplary frame apparatus may be raised or lowered by the vehicle so as to raise or lower the implement 510 to engage a ground surface. For example, the mount portion 520 may be couplable to and/or coupled to a frame apparatus that extends transverse to the forward moving direction of a vehicle and the frame apparatus may be coupled to a hydraulic system of the vehicle to raise and lower the implement 510 when used in conjunction with the vehicle.

The mount portion 520 may be configured to transmit force to the roller apparatus 540 from the vehicle to maintain engagement between the roller apparatus 540 and a ground surface when the roller apparatus 540 is rolled over the ground surface. For example, the vehicle may provide a force, or may allow the mass of the implement 510 itself to provide a force, to direct the roller apparatus 540 in engagement with the ground surface when in use, and the mount portion 520 may facilitate, or transmit, that force to the roller apparatus 540. Additionally, the mount portion 520 may be configured to transmit force to the roller apparatus 540 by being biased in a clockwise direction about a pivot axis. Other methods of transmitting force to the roller apparatus 540 may be used such as, e.g., airbags, a bellows suspension system, the weight of substance (e.g., fertilizer) tanks positioned thereon, a torsional spring system, a linear spring actuator system, a rotary or linear hydraulic actuator/accumulator system, etc.

The extension member 530 may extend from a proximal end portion 532 to a distal end portion 534 and may be pivotally coupled to the mount portion about the pivot axis. As used herein, “pivotally coupled” may be defined as a coupling between objects such that the objects are configured for pivotal movement in relation to each other. As depicted, the mount portion 520 may be pivotally coupled to the proximal end portion 532 of the extension member 530 through the use of an elongate torsion assembly 580 (see, e.g., a “Henschen” suspension as described in U.S. Pat. No. 3,436,069 entitled “Bearing Assembly for Elastic Joints” and issued to Henschen on Apr. 1, 1969 and U.S. Pat. App. Pub. No. 2007/0024016 A1 entitled “Parallel Torsion Suspension Assembly” published on Feb. 1, 2007, each of which are hereby incorporated by reference in their entireties).

In other embodiments, the mount portion may be pivotally coupled to the proximal end portion of the extension member through the use of, for example, a spring, a strut, a shock absorber, a linear spring/damper system, a rotary or linear hydraulic actuator/accumulator system or any suitable suspension element or system or combination of such elements or systems, etc.

The extension member 530 may be made, or formed of, metal such as steel, aluminum, cast iron, plastic (e.g., for example, fiber-reinforced or glass-filled) or any other suitable material. Further, the extension member 530 may be formed by cutting (e.g., laser cutting, stamping, blanking, water-jet cutting, or plasma cutting, etc.) a sheet of material and then bending, or forming, the sheet of material into the desired shape. Additionally, the extension member 530 may be formed using any suitable method including casting, forging or injection molding. As shown, one or more cutouts may be defined, or formed, in the extension member 530 to, e.g., reduce weight, provide access points for serviceability, provide debris cleanout and/or flow-through for debris, etc.

The distal end portion 534 of the extension member 530 may extend towards the ground surface and may be coupled to the roller apparatus 540 to locate the roller apparatus 540 proximate the ground surface such that the roller apparatus 540 may engage and contact the ground (e.g., for example, continuously, to ensure that the roller apparatus 540 outer surface 543 of the cylindrical portion 541 maintains contact with the ground surface and does not bounce off the ground surface, or intermittently, so that the roller apparatus 540 or the outer surface 543 of the cylindrical portion 541 maintains contact with the ground surface at least a portion of the time) when in use.

The roller apparatus 540 may be configured to engage and lift ground material to disperse the ground material and/or form a plurality of reservoirs in the ground surface as the implement 510 traverses the ground surface. As the roller apparatus 540 traverses the ground surface, the roller apparatus 540 may roll over the ground surface. To facilitate the rotational motion of the roller apparatus 540, the roller apparatus 540 may be rotatably coupled to the distal end portion 534 of the extension member 530 about a roller axis. As used herein, “rotatably coupled” may be defined as a coupling between objects such that the objects are rotatable in relation to each other.

The roller apparatus 540 may include a cylindrical portion 541 defining an outer surface 543 and a plurality of ground displacing elements 560 (e.g., soil displacing elements). The cylindrical portion 541 may extend from a first end portion to a second end portion defining a roller width. The roller width (e.g., for example, a roller width sized to be positioned between crop rows) may be about 8 inches to about 42 inches, such as, e.g., about 8 inches, about 12 inches, about 21 inches, about 22 inches, about 24 inches, about 42 inches, or any size in between those described herein, but not limited thereto, etc., and may be dependent on the distance between crop rows for which the implement is intended to be used. Each of the first end portion and the second end portion may be rotatably coupled to the extension member 530 about the roller axis such that the roller apparatus 540 is rotatably coupled to the extension member 530.

The plurality of ground displacing elements 560 may be coupled to the cylindrical portion 541 and extend outwardly from the outer surface 543 of the cylindrical portion 541. The plurality of ground displacing elements 560 may be configured to extend into the ground, or beyond the ground surface, to engage and lift ground material when the outer surface 543 of the cylindrical portion 541 is engaged with the ground surface as the roller apparatus 540 and portions thereof such as the cylindrical portion 541 are rolled over the ground surface. After the ground material is lifted by the ground displacing elements 560, the ground displacing elements 560 may disperse the ground material. In one or more embodiments, the ground material may be dispersed to the sides of the roller apparatus 540, e.g., direction traverse to the forward moving motion of the vehicle. Further, the ground displacing elements 560 may be described as being configured to dig, remove, separate, break apart, rip, and/or lift the ground material out of the ground, and subsequently, disperse the ground material.

As noted, the outer surface 543 of the cylindrical portion 541 may be configured to engage the ground surface when the cylindrical portion 541 is rolled over the ground surface. As used herein, “engage a ground surface” may be defined as touching, or contacting, the ground surface while the object is in use. For example, when the outer surface 543 of the cylindrical portion 541 of the roller apparatus 540 engages the ground surface, at least a portion of the outer surface 543 may touch, or be in contact, with the ground surface at least a portion of the time when in use. Further, in one or more embodiments, the exemplary implement 510 may be configured such that the outer surface 543 of the cylindrical portion 541 engages, or contacts, the ground continuously or intermittently when in use (e.g., the suspension apparatus coupling the mount portion 520 to the extension member 530 may transmit force to the roller apparatus 540 to provide continuous or intermittent engagement between the outer surface 543 of the cylindrical portion 541 and the ground surface).

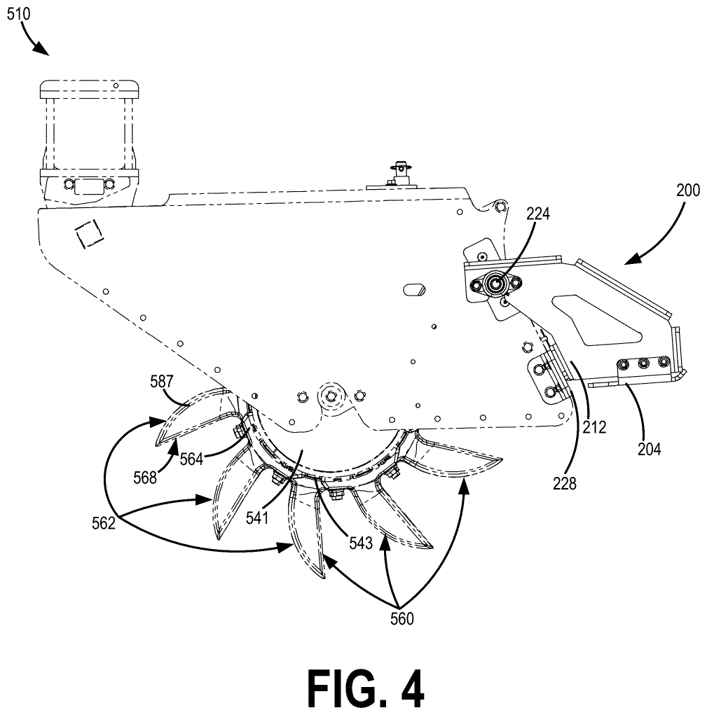

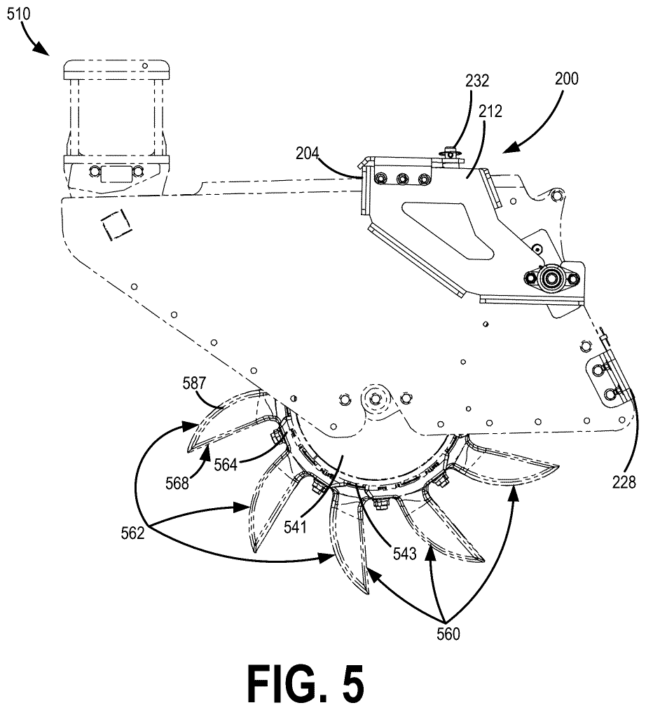

As shown in FIGS. 4 and 5, the roller apparatus 540 may include cylindrical portion 541, which defines an outer cylindrical surface 543. The plurality of ground displacing elements 560 may be removably coupled to the cylindrical portion 541 (e.g., adjacent to the outer cylindrical surface 543, in contact with the outer cylindrical surface 543, etc.). The plurality of ground displacing elements 560 may be arranged in a plurality of rows that circumferentially extend around the outer cylindrical surface 543. In this embodiment, the plurality of ground displacing elements 560 may be arranged, or grouped, in three rows. In other embodiments, the plurality of ground displacing elements 560 may be arranged, or grouped, in more than three rows such as, e.g., four rows, six rows, etc. or less than three rows such as, e.g., two rows and one row. Additionally, in this embodiment, the plurality of ground displacing elements 560 may be described as being in a staggered configuration or arrangement. In other words, it may be described that the plurality of ground displacing elements 560 are staggered with respect to each other such that each of the plurality of ground displacing elements 560 do not extend from the same location, or point, about the circumference of the cylindrical portion as any other of ground displacing elements 560 (e.g., located in other rows). Further, although in this embodiment, all of the plurality of ground displacing elements 560 are staggered with respect to each other, it is to be understood that, in some embodiments, two or more rows of ground displacing elements 560 may be aligned with each other (e.g. located at the same point, or location, about the circumference of the cylindrical portion 541).

Each of the ground displacing elements 560 may include a blade portion 562 and an attachment portion 564 coupled (e.g., fixedly coupled, integral to, etc.) to the blade portion 562. The attachment portion 564 may be removably coupled to the cylindrical portion 541. More specifically, the attachment portion 564 may be removably coupled to the cylindrical portion 541 such that the attachment portion 564 is adjacent, or in contact with, at least a region or section of the outer cylindrical surface 543 of the cylindrical portion 541.

Further, in one or more embodiments, the blade portion 562 of the ground displacing elements 560 defines, or includes, a ground lifting surface 568 that may be described as being bent or angled. Further, the blade portion 562 can include a chisel edge 587. The chisel edge 587 may be described as an edge of a blade or knife configured to cut into the ground surface. The chisel edge 587 may engage the ground surface prior to the remainder of the ground displacing element 560 when the roller apparatus 540 is engaged with the ground surface as the vehicle traverses the ground.

Further, as shown in FIGS. 4 and 5, the chisel edge 587 extends around the perimeter, or at least a portion (e.g., the majority) of the perimeter of the blade portion 562. More specifically, the chisel edge 587 may be described as being included or defined on a forward or leading edge of the blade portion 562 and a rear or trailing edge of the blade portion 562. The forward edge may be further described as being opposite the rearward edge as, e.g., the forward edge may face the direction of rotation while the rearward edge may face opposite the direction of rotation of the cylindrical portion. The chisel edge 587 may be described as extending entirely around the blade portion 562 except for an attachment region where the blade portion 562 is attached, or fixed, to the attachment portion 564. Further, the chisel edge 587 may be described as the first portion or region of the blade portion 562 to enter or contact the ground surface when being used to engage and disperse ground material.

Further, the blade portions 562 of the ground displacing elements 560 may be described as being tilted or rotated about an axis with respect to the forward moving direction of the implement 510. The axis may extend from the cylindrical portion radially (e.g., perpendicularly to a tangent of the circumference of the cylindrical portion) and the blade portions 562 may be described as being rotated, or angled, about the axis with the forward moving direction being zero degrees. In other words, the blade portions 562 may extend out of a plane lying parallel to the forward moving or rolling direction of the implement 510. Further, the plurality of ground displacing elements 560 may include blade portions 562 tilted, or rotated, in different (e.g., opposite) directions.

In other words, the blade portions 562 may each being described as lying, or extending, in a plane, and the plane may not be perpendicular (or parallel) to the rolling axis of the cylindrical portion 541. For example, the plane within which the blade portion lies may be considered to be twisted, or angled, from the radial axis, or line, which is perpendicular to the rolling axis of the cylindrical portion 541.

The blade portions 562 of the ground displacing elements 560 may be described as being tilted or rotated about the axis from the forward moving direction between about 0 and about 45 degrees. In one or more embodiments, the blade portions 562 of the ground displacing elements 560 may be described as being tilted or rotated about the axis from the forward moving direction greater than or equal to about 2 degrees, greater than or equal to about 4 degrees, greater than or equal to about 5 degrees, greater than or equal to about 8 degrees, greater than or equal to about 10 degrees, greater than or equal to about 12 degrees, greater than or equal to about 14 degrees, greater than or equal to about 16 degrees, greater than or equal to about 20 degrees, greater than or equal to about 25 degrees, greater than or equal to about 30 degrees, greater than or equal to about 35 degrees, etc. Further, in one or more embodiments, the blade portions 562 of the ground displacing elements 560 may be described as being tilted or rotated about the axis from the forward moving direction less than or equal to about 45 degrees, less than or equal to about 40 degrees, less than or equal to about 38 degrees, less than or equal to about 34 degrees, less than or equal to about 32 degrees, less than or equal to about 27 degrees, less than or equal to about 23 degrees, less than or equal to about 18 degrees, less than or equal to about 13 degrees, less than or equal to about 11 degrees, less than or equal to about 9 degrees, less than or equal to about 7 degrees, less than or equal to about 3 degrees, etc.

Additionally, the ground lifting surface 568 of the blade portion 562 may be described as extending at non-radial angle. For example, substantially all or a majority of the ground lifting surface 568 may not extend along a radial line (e.g., a line that extends through the rolling axis of the cylindrical portion 541). Further, the ground lifting surface 568 may be described as being forward slanted or angled towards the rolling direction of the cylindrical portion 541.

Furthermore, in one or more embodiments, the implement apparatus 510 may also include additional components to work the ground material, e.g., between rows of crops or to clean a row of crop after harvest or before planting. As shown in FIGS. 3-5, the implement apparatus 510 can include a mounting apparatus 200 movably coupled (e.g., pivotally coupled) to the distal end portion 534 of the extension member 530. The mounting apparatus 200 can include a mounting plate 204 configured to mount a number of different ground working elements (e.g., components, devices, apparatus, etc.) for use in working the soil between rows of crops. The mounting plate 204 can include a number of mounting holes 208 that can mount various ground working elements such as a bermer, a hipper, and a crumbler as will be described further herein.

As shown, the mounting apparatus 200 can include a first arm 212 and a second arm 216 extending away from a pivot end 220 of the mounting apparatus 200 towards the mounting plate 204. The first arm 212 and the second arm 216 can be coupled and/or attached to the mounting plate 204. At the pivot end 220, the mounting apparatus 200 can be movably coupled with the extension member 530. Each of the first arm 212 and the second arm 216 can include an opening configured to receive a pin or axle 224 that extends partially or fully through the extension member 530. The first arm 212 and the second arm 216 of the mounting apparatus can then rotate (e.g., pivot) around the axle 224.

The mounting apparatus 200 can move between a first configuration shown in FIG. 4 and a second configuration shown in FIG. 5. In the first configuration, the mounting apparatus 200 can extend from the distal end portion 534 of the extension member 530 away from the extension member 530. In some embodiments, the mounting apparatus 200 can rest on stops 228 coupled to the distal end portion 534. In the first configuration, the mounting apparatus 200 can position a ground working element so as to engage the ground surface when the vehicle traverses the ground surface to allow the ground working element to work the ground material. Various ground working elements will be discussed below. In the second configuration, the mounting apparatus 200 can extend from the distal end portion 534 substantially towards the proximal end portion 532 of the extension member 530. In the second configuration, the mounting apparatus 200 can position a ground working element so as to not engage the ground surface when the vehicle traverses the ground surface. In some embodiments, the mounting apparatus 200 can include a locking apparatus 232 configured to retain the mounting apparatus 200 in the second configuration. Further, the locking apparatus 232 may prevent the mounting apparatus 200 from falling into the first configuration while in the second configuration.

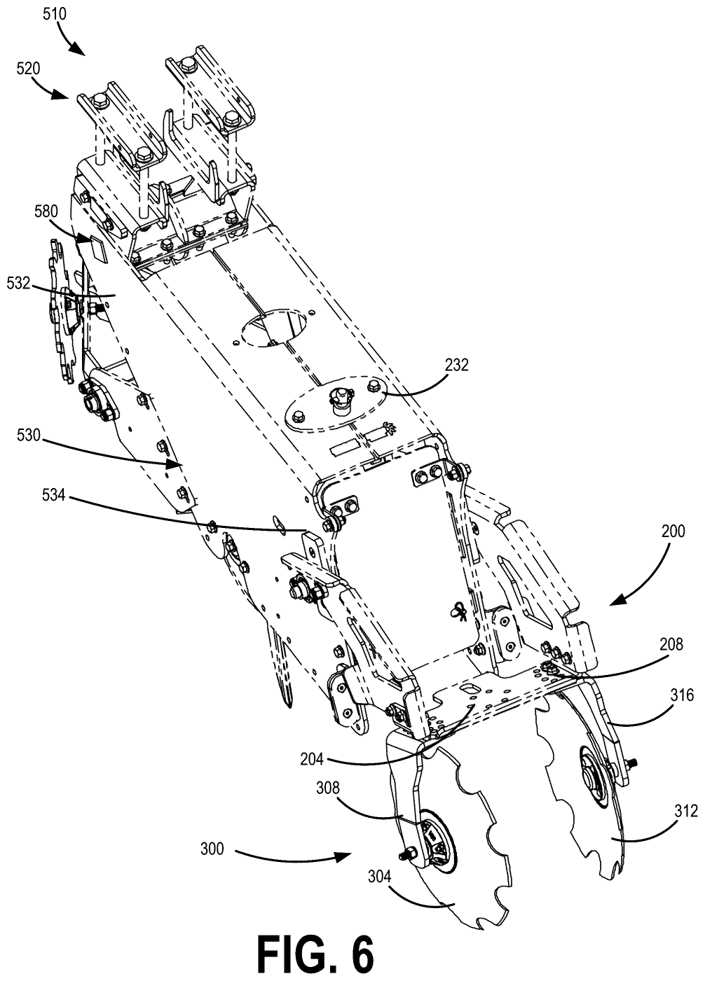

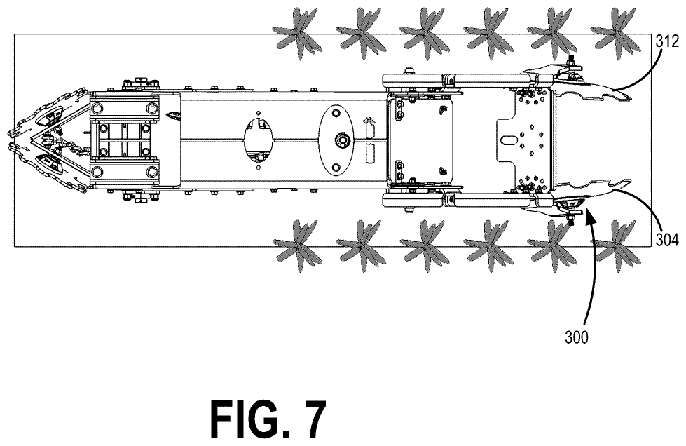

Referring now to FIGS. 6 and 7 as well as FIGS. 1-5, an implement apparatus including a bermer or berming apparatus is shown. Specifically, the implement apparatus 510 is shown coupled to a bermer 300. The bermer 300 includes a first wheel 304 rotatably coupled to a first bracket 308 and a second wheel 312 rotatably coupled to a second bracket 316. The bermer 300 can be configured to direct material perpendicularly towards an axis of travel of a vehicle along the ground surface. More specifically, the bermer 300 can create a berm (e.g., a heightened area of ground material) between adjacent crop rows as the vehicle travels along the crop rows.

The first bracket 308 can be attached and/or coupled to the mounting plate 204 using the mounting holes 208. For example, one or more bolts extending through one or more of the mounting holes 208 can affix the first bracket 308 to the mounting plate 204. The plurality of mounting holes 208 can provide multiple mounting angles for the first bracket 308, which can angle the first wheel 304 at multiple different angles depending on application and/or user preferences. By choosing which mounting hole(s) 208 to which the first bracket 308 is mounted, a toe in angle of the first wheel 304 can be modified. In other words, the plurality of mounting holes 208, and thus the mounting apparatus, can provide multiple “toe-in” angles for the bermer 300. The toe-in angles may range from zero degrees to three degrees away from an axis of the direction of travel.

The second bracket 316 can be attached and/or coupled to the mounting plate 204 using the mounting holes 208. For example, one or more bolts extending through one or more of the mounting holes 208 can affix the second bracket 316 to the mounting plate 204. The plurality of mounting holes 208 can provide multiple mounting angles for the second bracket 316, which can angle the second wheel 312 at multiple different angles depending on application and/or user preferences. By choosing which mounting hole(s) 208 to which the second bracket 316 is mounted, a toe in angle of the second wheel 312 can be modified. By adjusting toe in angles of the first wheel 304 and the second wheel 312, the shape of the berm formed by the bermer 300 can be chosen according to application and/or user preference.

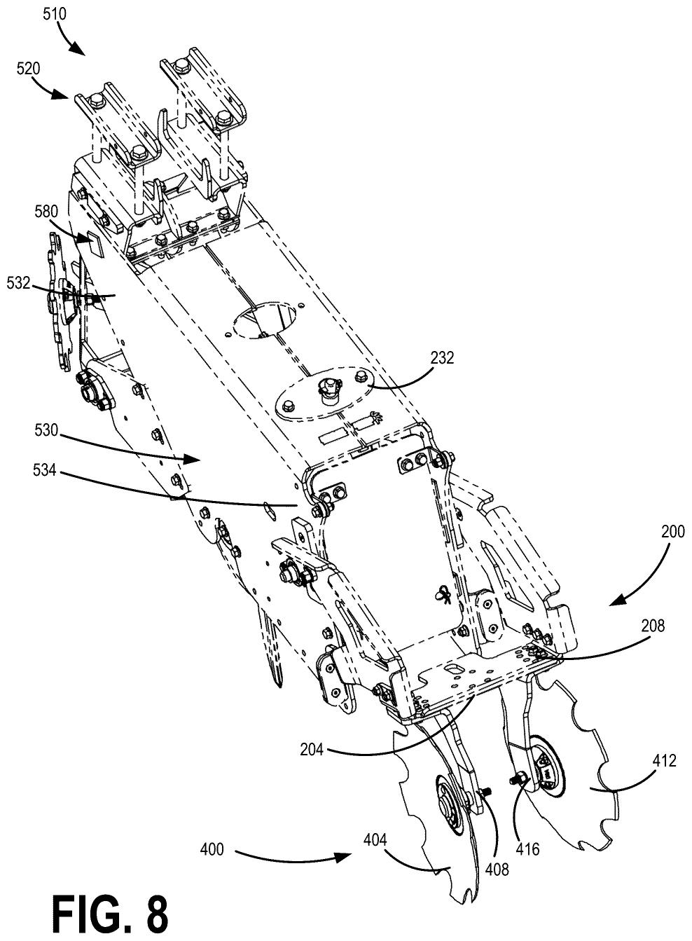

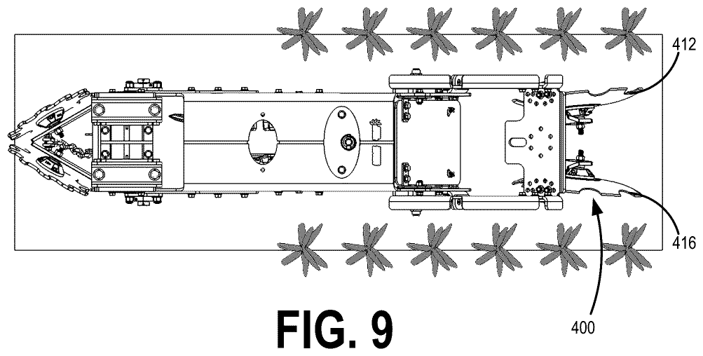

Referring now to FIGS. 8 and 9 as well as FIGS. 1-5, an implement apparatus including a hipper is shown. Specifically, the implement apparatus 510 is shown coupled to a hipper 400. The hipper 400 includes a first wheel 404 rotatably coupled to a first bracket 408 and a second wheel 412 rotatably coupled to a second bracket 416. The hipper 400 can be configured to direct material perpendicularly away from an axis of travel of a vehicle along the ground surface. More specifically, the hipper 400 can create direct dirt towards adjacent crop rows as the vehicle travels along the crop rows.

The first bracket 408 can be attached and/or coupled to the mounting plate 204 using the mounting holes 208. For example, one or more bolts extending through one or more of the mounting holes 208 can affix the first bracket 408 to the mounting plate 204. The plurality of mounting holes 208 can provide multiple mounting angles for the first bracket 408, which can angle the first wheel 404 at multiple different angles depending on application and/or user preferences. By choosing which mounting hole(s) 208 to which the first bracket 408 is mounted, a toe in angle of the first wheel 404 can be modified. In other words, the plurality of mounting holes 208, and thus the mounting apparatus, can provide multiple toe in angles for the hipper 400.

The second bracket 416 can be attached and/or coupled to the mounting plate 204 using the mounting holes 208. For example, one or more bolts extending through one or more of the mounting holes 208 can affix the second bracket 416 to the mounting plate 204. The plurality of mounting holes 208 can provide multiple mounting angles for the second bracket 416, which can angle the second wheel 412 at multiple different angles depending on application and/or user preferences. By choosing which mounting hole(s) 208 to which the second bracket 416 is mounted, a toe in angle of the second wheel 412 can be modified. By adjusting “toe-in” angles of the first wheel 404 and the second wheel 412, the hipping performed by the hipper 400 can be chosen according to application and/or user preference. The toe-in angles may range from zero degrees to three degrees towards an axis of the direction of travel.

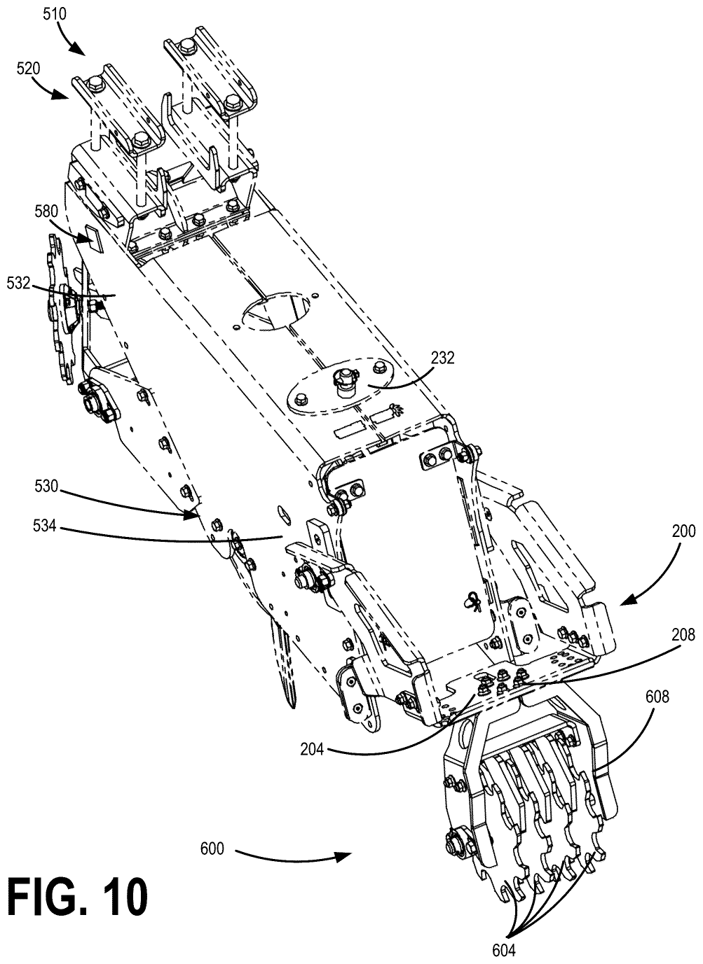

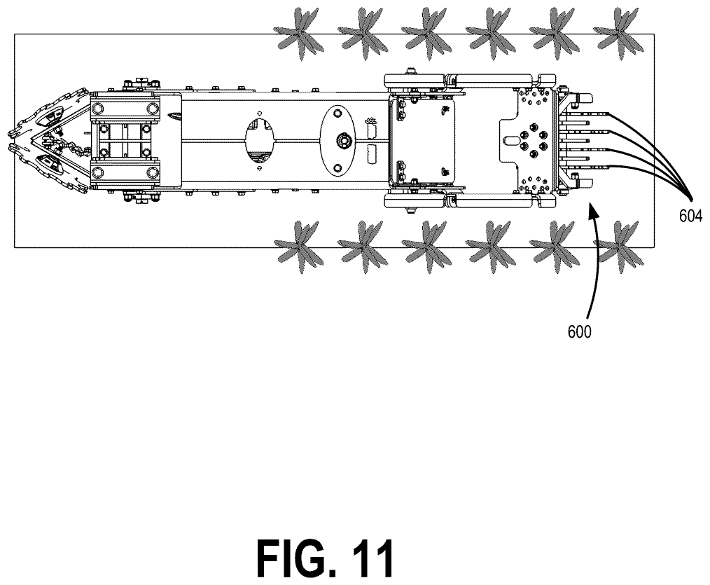

Referring now to FIGS. 10 and 11 as well as FIGS. 1-5, an implement apparatus including a hipper is shown. Specifically, the implement apparatus 510 is shown coupled to a crumbler or crumbling apparatus 600. The crumbler 600 includes a plurality of wheels 604 rotatably coupled to a bracket 608. The bracket 608 can be coupled to the mounting plate 204 using the plurality of mounting holes 208. The crumbler 600 can be configured to crumble dirt particles and/or clumps and/or reduce the size of the dirt particle and/or clumps between crop rows as the vehicle travels along the crop rows.

Referring now to FIGS. 10 and 11 as well as FIGS. 1-5, an implement apparatus including a crumbler is shown. Specifically, the implement apparatus 510 is shown coupled to a crumbler 600. The crumbler 600 includes a plurality of wheels 604 rotatably coupled to a bracket 608. The bracket 608 can be coupled to the mounting plate 204 using the plurality of mounting holes 208. The crumbler 600 can be configured to crumble dirt particles and/or clumps and/or reduce the size of the dirt particle and/or clumps between crop rows as the vehicle travels along the crop rows.

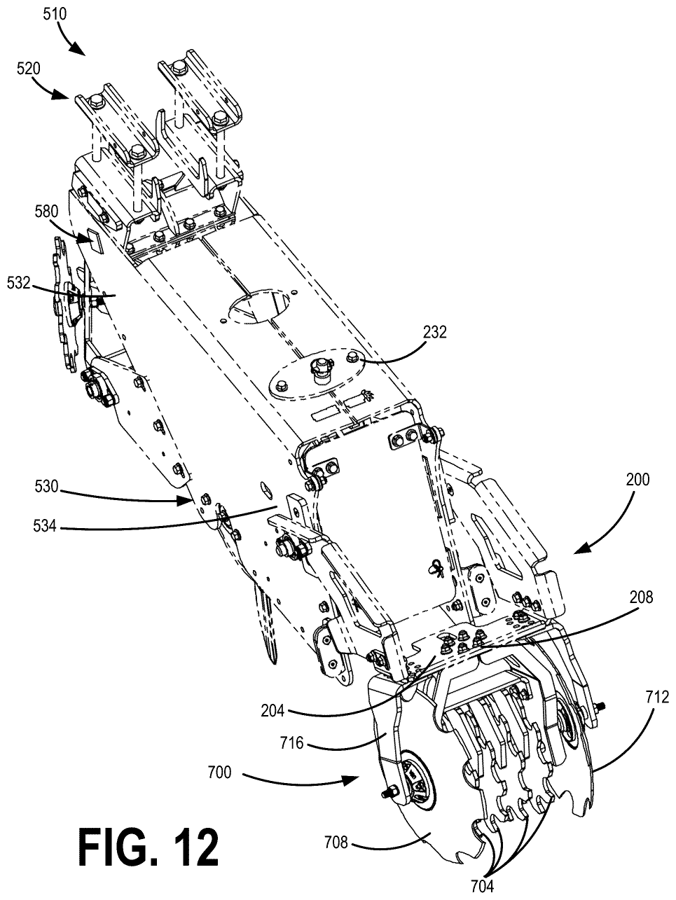

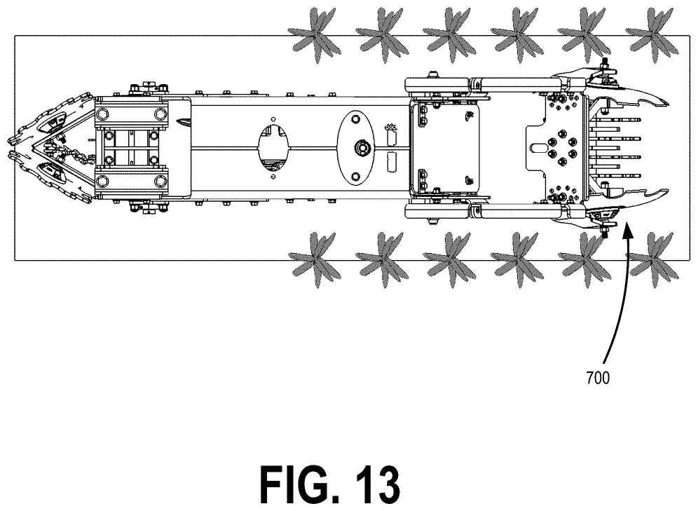

Referring now to FIGS. 12 and 13 as well as FIGS. 1-5, an implement apparatus including a bermer and crumbler is shown. Specifically, the implement apparatus 510 is shown coupled to a bermer and crumbler combination apparatus 700. The bermer and crumbler combination apparatus 700 includes a plurality of crumbler wheels 704 rotatably coupled to a bracket 716. The crumbler wheels 704 may be substantially the same as the wheels 604 in the crumbler 600 of FIG. 10. The bracket 716 can be coupled to the mounting plate 204 using the plurality of mounting holes 208. In some embodiments, the mounting holes 208 used to mount the bracket 716 can be the same as the mounting holes 208 used to mount the crumbler 600 in FIG. 6. The bermer and crumbler combination apparatus 700 can be configured to crumble dirt particles and/or clumps and/or reduce the size of the dirt particle and/or clumps between crop rows as the vehicle travels along the crop rows.

Additionally, the bermer and crumbler combination apparatus 700 includes a first berming wheel 708 and a second berming wheel 712. The first berming wheel 708 and a second berming wheel 712 can be substantially the same as the first wheel 304 and the second wheel 312, respectively, included in the bermer 300 in FIG. 6. By using both berming and crumbling wheels, the bermer and crumbler combination apparatus 700 can perform both berming and crumbling functions between adjacent. crop rows in a single pass of the crop rows.

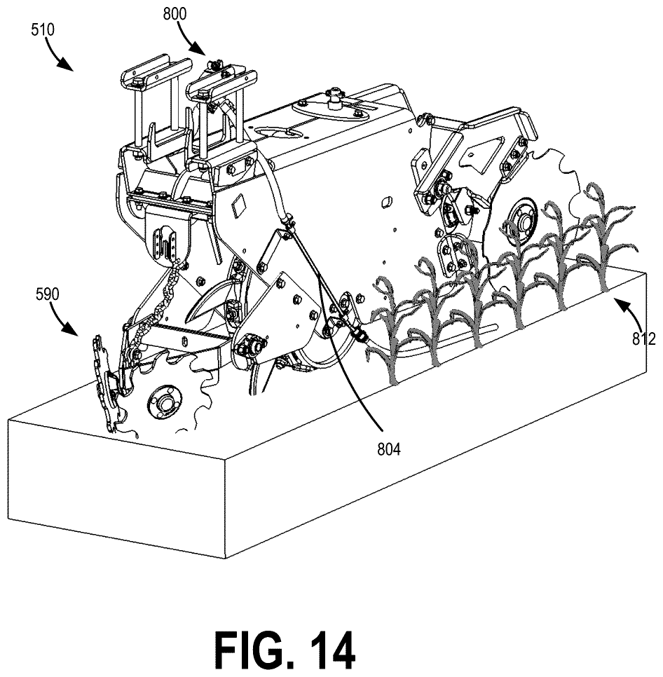

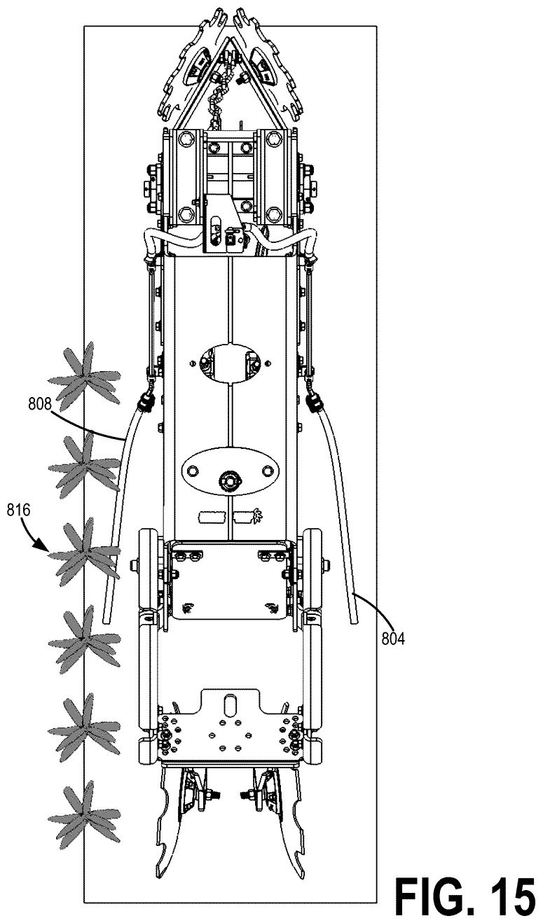

Referring now to FIGS. 14 and 15 as well as FIGS. 1-5, an implement apparatus including a dropper apparatus is shown. Specifically, the implement apparatus 510 is shown coupled to a dropper apparatus 800. In some embodiments, the implement apparatus 510 can include a cleaner apparatus 590. The dropper apparatus 800 can include a first dropper 804 and a second dropper 808. The first dropper 804 can be configured to dispense fertilizer to a first crop row 812, and the second dropper 808 can be configured to dispense fertilizer to a second crop row 816 adjacent to the first crop row 812.

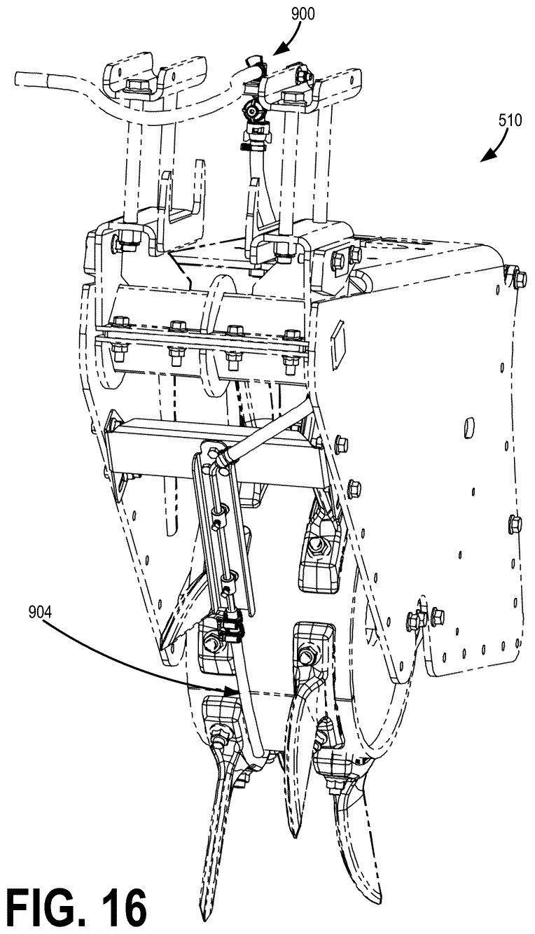

Referring now to FIG. 16 as well as FIGS. 1-5, an implement apparatus including a dropper apparatus is shown. Specifically, a portion of the implement apparatus 510 is shown coupled to a dropper apparatus 900. The dropper apparatus 900 includes a dropper 904 configured to dispense liquid material, such as, e.g., fertilizer, herbicide, pesticide, water, etc., between a first crop row and a second crop row immediately adjacent to the first crop row.

Each of the bermer 300, the hipper 400, the crumbler 600, and the bermer and crumbler combination apparatus 700 can be coupled to the mounting apparatus 200 interchangeably. In other words, the mounting apparatus facilitates the use of bermers, hippers, and crumblers as a user. Additionally, each of the bermer 300, the hipper 400, the crumbler 600, and the bermer and crumbler combination apparatus 700 can be positioned in between immediately adjacent crop rows, which allows a user to perform multiple function without changing where a vehicle is piloted relative to crop rows. Furthermore, the dropper apparatus 800 and/or the dropper apparatus 900 can be used with any of the bermer 300, the hipper 400, the crumbler 600, and the bermer and crumbler combination apparatus 700 being mounted to the mounting apparatus 200, providing further flexibility for the user. Still further, the bermer 300 and the hipper 400 can be made from the same parts, and the parts can act as either a bermer or a hipper based on how the parts are mounted to the mounting apparatus. For example, the mounting holes 208 may provide positions to mount the bermer 300 as the hipper 400, as well as positions to mount the hipper 400 as the bermer 300.

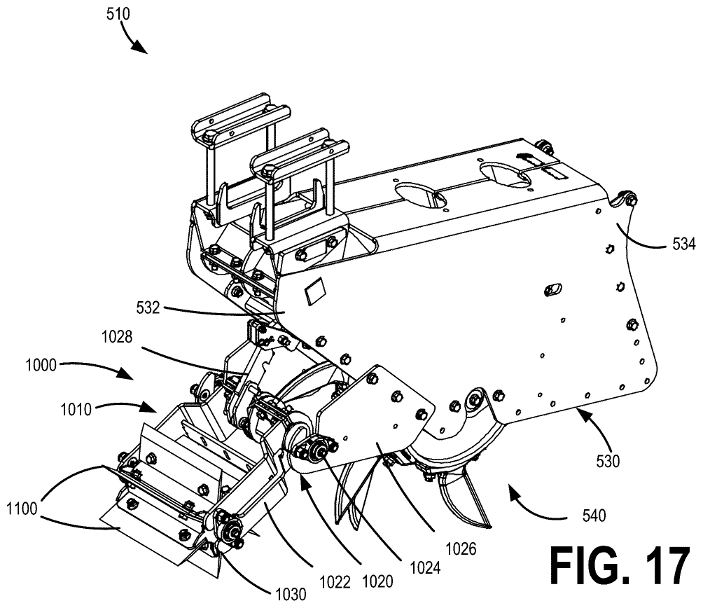

FIG. 17 depicts an illustrative implement apparatus 510 including a chopping apparatus 1000. The chopping apparatus 1000 is coupled to the extension member 530 of implement apparatus 510 and includes a plurality of cutting blades 1100 adapted to rotate relative to the ground surface and oriented such that the plurality of cutting blades 1100 are perpendicular to a direction the vehicle (e.g., the vehicle 10 in FIG. 1) is traversing along the ground surface. In one or more embodiments, the chopping apparatus 1000 breaks apart ground material such as, e.g., vegetation, stalks, crops, etc.

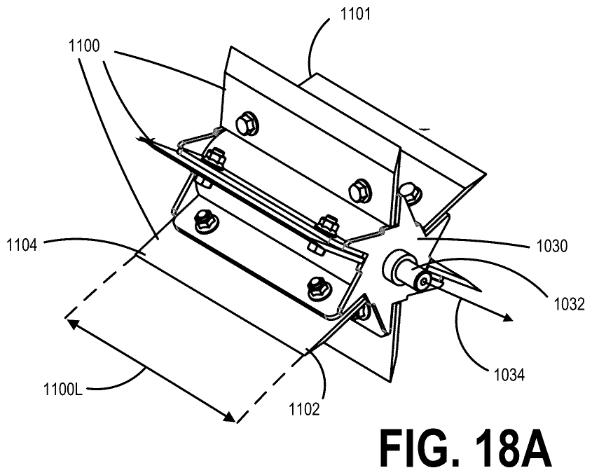

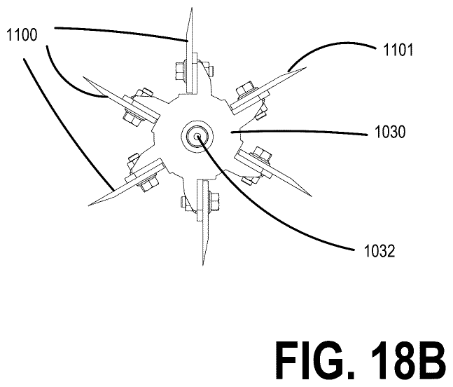

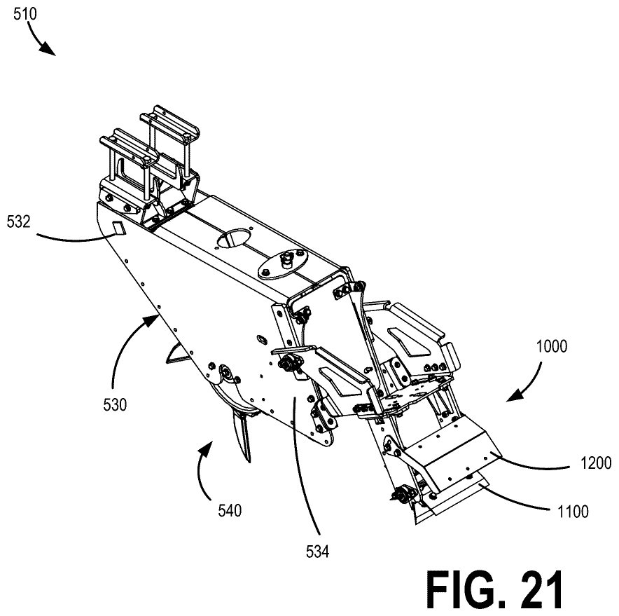

The chopping apparatus 1000 may be coupled to any suitable portion or portions of the implement apparatus 510 so as to be able to breaks apart ground material into a desirable size. As illustrated in FIG. 17, the chopping apparatus 1000 is coupled to the proximal end portion 532 of the extension member 530 such that the chopping apparatus 1000 is forward from the roller apparatus 540. In one or more embodiments, the chopping apparatus 1000 may be coupled to the distal end portion 534 of the extension member 530 such that the chopping apparatus 1000 is positioned rearward from the roller apparatus 540 as illustrated in FIG. 21. The chopping apparatus 1000 may be coupled with the extension member 530 using any suitable technique or techniques. Examples of suitable techniques include mechanical fastening, welding, adhesively connecting, or any other suitable technique sufficient to support the force applied from the chopping apparatus 1000 to the ground material. The plurality of cutting blades will be further described herein with respect to FIGS. 18A and 18B.

The chopping apparatus 1000 may be made, or formed of, any suitable metal such as steel, aluminum, cast iron, plastic (e.g., for example, fiber-reinforced or glass-filled), or any other suitable material. Further, the chopping apparatus 1000 may be formed by cutting (e.g., laser cutting, stamping, blanking, water-jet cutting, or plasma cutting, etc.) a sheet of material and then bending, or forming, the sheet of material into the desired shape. Additionally, the extension member 530 may include (e.g., be formed using) any suitable method including casting, forging or injection molding. As shown, one or more cutouts may be defined, or formed, in the extension member 530 to, e.g., reduce weight, provide access points for serviceability, provide debris cleanout and/or flow-through for debris, etc.

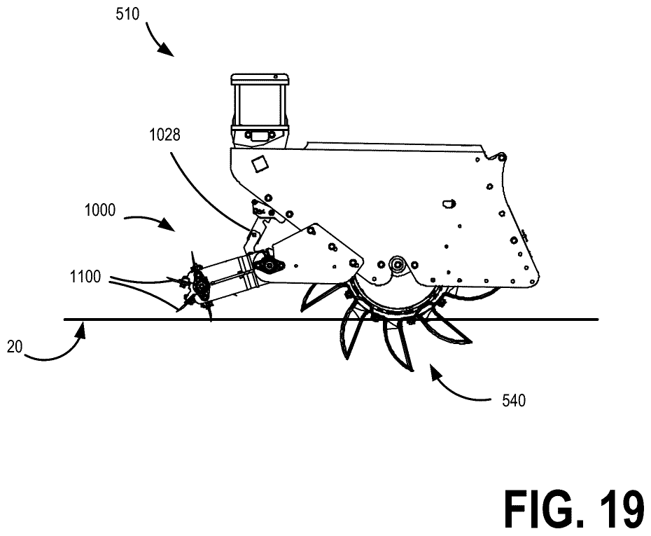

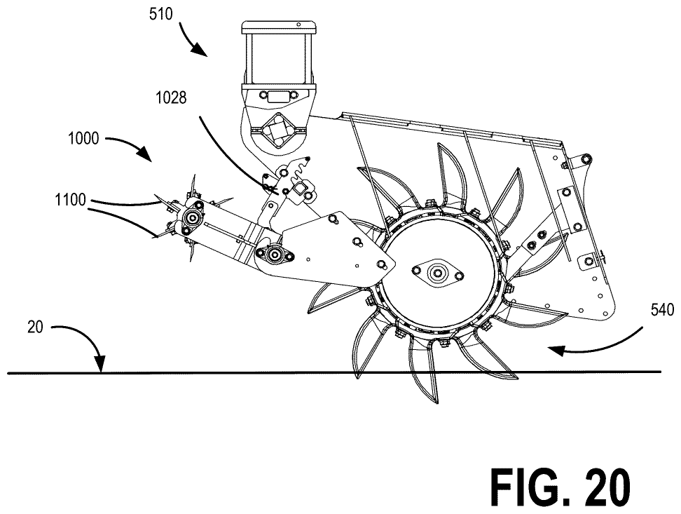

The chopping apparatus 1000 may be configured to transmit force to the plurality of cutting blades 1100 to break apart ground material such as, e.g., stems or stalks left from crops after harvesting. For example, when the plurality of cutting blades 1100 rotate and are in contact with the ground material, the ground material may be broken apart to smaller pieces. In one or more embodiments, the plurality of cutting blades 1100 chop ground material, e.g., stems, roots, stalks, etc., at or near the ground surface. In one or more embodiments, the plurality of cutting blades 1100 chop material away from the ground surface such that it does not contact the ground surface. The chopping apparatus 1000 may include a plurality of configurations to facilitate effective use and storage. For example, as described further in FIGS. 19 and 20, the chopping apparatus 1000 may include a storage configuration and a working configuration. The chopping apparatus 1000 may be configured for any suitable purpose where a rotatable apparatus with a plurality of cutting blades 1100 is advantageous.

The chopping apparatus 1000 may include a plurality of components. For example, the chopping apparatus 1000 may include an attachment portion 1010 configured to selectively couple the chopping apparatus 1000 to the extension member 530. The attachment portion 1010 may be configured to couple the extension member 530 with the plurality of cutting blades 1100. To provide the coupling between the extension member 530 and the plurality of cutting blades 1100, the attachment portion 1010 may further include a mounting portion 1020 and a rotatable portion 1030. The mounting portion 1020 may be coupled to the extension member 530. The rotatable portion 1030 may be rotatably coupled to the mounting portion 1020 and fixedly coupled to the plurality of cutting blades 1100.

The mounting portion 1020 and the rotatable portion 1030 may be coupled with any suitable components. As illustrated in FIG. 17, a plurality of components such as, e.g., link arm assemblies 1022, bearings 1024, bracket 1026, an adjustment arm 1028, or any other suitable components. Such components may be configured to provide rotation, downward force, or any suitable purpose to facilitate chopping.

Referring to FIGS. 18A and 18B, the plurality of cutting blades 1100 are coupled to the rotatable portion 1030 such that each of the cutting blades 1100 extend from the rotatable portion 1030. In this embodiment, a cutting axle 1032 couples the rotatable portion 1030 to the mounting portion 1020 of the chopping apparatus (shown in FIG. 17). More specifically, the cutting axle 1032 rotatably couples the rotatable portion 1030 to the mounting portion 1020 to facilitate rotation of the plurality of cutting blades 1100. The cutting axle 1032 rotates on a cutting axis 1034 of rotation defined by the center of the cutting axle 1032. The cutting axis 1034 is substantially perpendicular to the direction the vehicle (e.g., the vehicle 10 in FIG. 1) is travelling across the ground surface 20 (shown in FIG. 19-20).

As illustrated by FIGS. 18A and 18B, the plurality of cutting blades 1100 extend radially from the rotatable portion 1030. In one or more embodiments, the plurality of cutting blades 1100 extend from the rotatable portion 1030 at any suitable angle. In one or more embodiments, each of the plurality of cutting blades 1100 may be at different angles extending from the rotatable portion 1030.

The plurality of cutting blades 1100 may include any suitable number of blades. For example, as illustrated in FIGS. 17-18, the chopping apparatus 1000 includes six cutting blades coupled to the rotatable portion 1030. In one or more embodiments, the chopping apparatus 1000 may include more than six cutting blades. In one or more embodiments, the chopping apparatus 1000 may include less than six cutting blades. Furthermore, the plurality of cutting blades 1100 may be any suitable material with an edge that is configured to provide sufficient force to break apart a material when a force is applied. For example, in one or more embodiments, the weight of an implement apparatus 510 may provide the force necessary to break apart ground material. In other embodiments, other non-gravitational forces are required to break apart ground material.

Each of the plurality of cutting blades 1100 may be made, or formed of, any suitable material or materials. Suitable materials may include metals, ceramics, plastic (e.g., for example, fiber-reinforced or glass-filled), or any other suitable material. Examples of suitable metals may include steel, aluminum, cast iron, or any other suitable metals or metal alloys. Further, cutting blades 1100 may be formed by cutting (e.g., laser cutting, stamping, blanking, water-jet cutting, or plasma cutting, etc.) a sheet of material and then grinding, or forming, the sheet of material into the desired shape. Additionally, each of the cutting blades 1100 may be formed using any suitable method including casting, forging or injection molding.

Further, in one or more embodiments, the plurality of cutting blades 1100 may define, or include, a cutting edge 1101. The cutting edge 1101 may be described as an edge of a blade or knife configured to cut in a ground material, or above ground material (e.g., stalks, debris, etc.). The cutting edge 1101 may engage the ground surface prior to the remainder of the ground displacing element (560 of FIG. 5) when the roller apparatus (540 of FIG. 17) is engaged with the ground surface as the vehicle traverses the ground. The cutting edge 1101 may be any suitable shape or size configured for any suitable ground material.

Further, as shown in FIGS. 18A and 18B, the cutting edge 1101 may extend across around the length 1100L, or at least a portion (e.g., the majority) of the length 1100L of each of the cutting blades 1100. More specifically, the cutting edge 1101 may be described as being included or defined on a forward or leading edge of the blade portion 562 and a rear or trailing edge of each of the cutting blades 1100.

The plurality of cutting blades 1100, when coupled to the rotatable portion 1030, may be spaced apart by any suitable distance. As illustrated in FIG. 18B, each of the plurality of cutting blades 1100 are spaced apart from one another about the rotatable portion 1030 between a 45 degree angle to a 75 degree angle. In one or more embodiments, the plurality of cutting blades 1100 are spaced apart from one another about the rotatable portion 1030, at a lower end, at an angle of, e.g., 30 degrees or more, 45 degrees or more, 60 degrees or more, 75 degrees or more, or 90 degrees or more. In one or more embodiments, the plurality of cutting blades 1100 are spaced apart from one another about the rotatable portion 1030, at an upper end, at an angle of, e.g., 180 degrees or less, 120 degrees or less, 90 degrees or less, 75 degrees or less, 60 degrees or less, or 45 degrees or less.

The plurality of cutting blades 1100 may be any suitable shape or size. For example, the blades may be flat, curved, or any other suitable shape. Each of the plurality of cutting blades 1100 may be oriented in any suitable direction which may include the same direction or different directions.

Each of the plurality of cutting blades 1100 may define a length 1100L defined by the distance substantially parallel to the cutting axis 1034 between a first end 1102 and a second end 1104. The length 1100L may be similar to a width defined by the rotatable portion 1030 in a direction substantially parallel to the cutting axis 1034.

When used herein, the term “substantially parallel” as used in connection with various components, axes, directions of travel, etc. includes both parallel and generally parallel arrangements. For example, two axes (or other components, features, etc.) may be described as “aligned with” when the axes (or other components, features, etc.) are both perfectly parallel with each other or nearly parallel, e.g., the axes (or other components, features, etc.) may form an angle with each other that is greater than 0° but 100 or less.

In one or more embodiments, each of the cutting blades 1100 may be different lengths 1100L. In one or more embodiments, each of the cutting blades 1100 may be less than the length 1100L. In one or more embodiments, each of the cutting blades 1100 may be staggered across the rotatable portion 1030. In one or more embodiments, each of the cutting blades 1100 may be oriented such that the length 1100L may be substantially parallel to the direction the vehicle (e.g., the vehicle 10 in FIG. 1) is traversing along the ground surface.

FIGS. 19 and 20 depict various configurations of the implement apparatus 510 and the chopping apparatus 1000. The chopping apparatus 1000 is moveable by an adjustment arm 1028 between a working configuration and a storage configuration.

As illustrated in FIG. 19, when in the working configuration, the plurality of cutting blades 1100 are positioned proximate to the ground surface 20. In one or more embodiments, when in the working configuration the plurality of cutting blades 1100 may be in contact with the ground surface 20. In one or more embodiments, when in the working configuration the plurality of cutting blades 1100 may be in contact with the ground surface 20 at a depth less than the depth of the roller apparatus 540.

As illustrated in FIG. 20, when in the storage configuration, the plurality of cutting blades 1100 are positioned further above the ground surface 20 than when in the working configuration. In one or more embodiments, when in the storage configuration, the plurality of cutting blades 1100 are not in contact with the ground surface 20. In one or more embodiments, when in the storage configuration, the plurality of cutting blades 1100 may be positioned 6 inches or more over the ground surface 20.

Referring to FIG. 21, the implement apparatus 510 may further comprise a chopping apparatus 1000 positioned rearward from the roller apparatus 540. In one or more embodiments, the chopping apparatus 1000 may be coupled to the extension member 530. In one or more embodiments, the chopping apparatus 1000 may be coupled to the distal end portion 534 of the extension member 530.

The implement apparatus 510 may further include a chopping apparatus 1000 with a cover 1200 configured to block ground material being dispersed from the plurality of cutting blades 1100 in a generally upward direction. In other words, the cover 1200 may be configured to stop the chopping apparatus 1000 from “throwing” material rearward from the implement apparatus 510.

The implement apparatus 510 may include any suitable number of covers 1200. The cover 1200 may be positioned in any suitable location or locations on the implement apparatus 510 such that ground material is being blocked. The cover 1200 may be made, or formed by, any suitable material (e.g., metal, ceramic, polymer, etc.) and using any suitable technique (e.g., molding, laser cutting, stamping, blanking, water-jet cutting, plasma cutting, die casting, 3D printing, etc.).

In one or more embodiments, the implement apparatus 510 may further include a second chopping apparatus that is positioned rearward from the roller apparatus 540 and coupled to the distal end portion 534 while maintaining a first chopping apparatus 1000 positioned forward from the roller apparatus 540 and coupled to the proximal end portion 532.

In any of the embodiments discussed herein, one or more ground breaking apparatuses (e.g., chopping apparatus, sweep blades, row crop sweeps, chisel elements, or sweep cultivators) may be coupled to any of the implements or systems described herein. The one or more ground breaking apparatuses may be configured to break up or loosen the ground material prior to the roller apparatus forming reservoirs in the ground surface (e.g., mounted ahead of the roller apparatus in the direction of travel). The one or more ground breaking apparatuses may be configured to break up or loosen the ground material behind the roller apparatus forming reservoirs in the ground surface (e.g., mounted behind the roller apparatus in the direction of travel).

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the exemplary apparatus described herein. Various modifications of the illustrative embodiments, as well as additional embodiments of the disclosure, will be apparent upon reference to this description.

1. An implement apparatus couplable to a vehicle configured to traverse a ground surface, wherein the implement apparatus comprises:
an extension member couplable to the vehicle and extending between a proximal end portion and a distal end portion;
a roller apparatus coupled to the extension member and configured to engage the ground surface when the vehicle traverses the ground surface, wherein the roller apparatus comprises:
a cylindrical portion defining an outer cylindrical surface and lying along a roller axis configured to rotate as the vehicle traverses the ground surface; and
a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface; and
a ground working element; and
a mounting apparatus movably coupled to the distal end portion of the extension member and configured to move between a first configuration to position the ground working element to engage the ground surface when the vehicle traverses the ground surface and a second configuration to position the ground working element so as to not engage the ground surface when the vehicle traverses the ground surface.

2. The implement apparatus of claim 1, wherein the ground working element comprises one or more of a crumbler, a hipper, and bermer.

3. The implement apparatus of claim 1, wherein the ground working element comprises a crumbler configured to crumble the ground material.

4. The implement apparatus of claim 1, wherein the ground working element comprises a hipper configured to direct the ground material perpendicularly away from an axis of travel along the ground surface.

5. The implement apparatus of claim 1, wherein the ground working element comprises a bermer configured to direct the ground material perpendicularly towards an axis of travel along the ground surface.

6. The implement apparatus of claim 1, wherein the ground working element is configured to engage the ground surface between a first crop row and a second crop row immediately adjacent to the first crop row.

7. The implement apparatus of claim 1 further comprising a locking apparatus, wherein the mounting apparatus is configured to engage the locking apparatus to retain the mounting apparatus in the second configuration.

8. The implement apparatus of claim 1, wherein the ground working element comprises:
a first wheel movably coupled to a first bracket, the first bracket configured to be attached to the mounting apparatus in a first position and a second position; and
a second wheel movably coupled to a second bracket, the second bracket configured to be attached to the mounting apparatus in a third position and a fourth position.

9. The implement apparatus of claim 8, wherein when the first bracket is mounted in the first position and the second bracket is mounted in the third position, the ground working element is configured to act as a hipper configured to direct material perpendicularly away from an axis of travel along the ground surface, and when the first bracket is mounted in the second position and the second bracket is mounted in the fourth position, the ground working element is configured to act as a bermer configured to direct material perpendicularly towards the axis of travel along the ground surface.

10. The implement apparatus of claim 1 further comprising:
a first dropper configured to dispense fertilizer to a first crop row; and
a second dropper configured to dispense fertilizer to second crop row immediately adjacent to the first crop row.

11. The implement apparatus of claim 1 further comprising:
a dropper coupled to the proximal end portion of the extension member and configured to dispense fertilizer between a first crop row and a second crop row immediately adjacent to the first crop row.

12. The implement apparatus of claim 1, wherein the ground working element comprises a hipper configured to direct material perpendicularly away from an axis of travel along the ground surface, the hipper comprising:
a first wheel configured to be mounted to the mounting apparatus at a first toe in angle and a second toe in angle; and
a second wheel configured to be mounted to the mounting apparatus at a third toe in angle and a fourth toe in angle.

13. The implement apparatus of claim 1, wherein the ground working element comprises a bermer configured to direct material perpendicularly towards an axis of travel along the ground surface, the bermer comprising:
a first wheel configured to be mounted to the mounting apparatus at a first toe in angle and a second toe in angle; and
a second wheel configured to be mounted to the mounting apparatus at a third toe in angle and a fourth toe in angle.

14. The implement apparatus of claim 1, wherein the implement apparatus is configured to be positioned between a first crop row and a second crop row immediately adjacent to the first crop row.

15. An implement apparatus couplable to a vehicle configured to traverse a ground surface between a first crop row and a second crop row immediately adjacent to the first crop row, wherein the implement apparatus comprises:
an extension member couplable to the vehicle and extending between a proximal end portion and a distal end portion; and
a roller apparatus coupled to the extension member and configured to engage the ground surface between the first crop row and the second crop row when the vehicle traverses the ground surface, wherein the roller apparatus comprises:
a cylindrical portion defining an outer cylindrical surface and lying along a roller axis configured to rotate as the vehicle traverses the ground surface; and
a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface; and
wherein the extension member is couplable to one or more of at least three different ground working elements, each of the at least three different ground working elements configured to engage the ground surface and work the ground surface in a different way than each other between the first crop row and the second crop row when the vehicle traverses the ground surface.

16. The implement apparatus of claim 15, wherein the implement apparatus is configured to be positioned between the first crop row and the second crop row.

17. The implement apparatus of claim 15, wherein the at least three different ground working elements comprises one or more of a crumbler, a hipper, and bermer.

18. The implement apparatus of claim 15, wherein the at least three different ground working elements comprises a crumbler configured to crumble the ground material.

19. The implement apparatus of claim 15, wherein the at least three different ground working elements comprises a hipper configured to direct the ground material perpendicularly away from an axis of travel along the ground surface.

20. The implement apparatus of claim 15, wherein the at least three different ground working elements comprises a bermer configured to direct the ground material perpendicularly towards an axis of travel along the ground surface.

21. The implement apparatus of claim 15, wherein each of the at least three different ground working elements is configured to engage the ground surface between the first crop row and the second crop row.

22. The implement apparatus of claim 15 further comprising:
mounting apparatus configured to couple each of the at least three different ground working elements to the extension member; and
a locking apparatus, wherein the mounting apparatus is configured to engage the locking apparatus to retain the mounting apparatus.

23. The implement apparatus of claim 15, wherein the ground working element comprises:
a mounting apparatus attached to the distal end portion of the extension member;
a first wheel movably coupled to a first bracket, the first bracket configured to be attached to the mounting apparatus in a first position and a second position; and
a second wheel movably coupled to a second bracket, the second bracket configured to be attached to the mounting apparatus in a third position and a fourth position.

24. The implement apparatus of claim 23, wherein when the first bracket is mounted in the first position and the second bracket is mounted in the third position, the ground working element is configured to act as a hipper configured to direct material perpendicularly away from an axis of travel along the ground surface, and when the first bracket is mounted in the second position and the second bracket is mounted in the fourth position, the ground working element is configured to act as a bermer configured to direct material perpendicularly towards the axis of travel along the ground surface.

25. The implement apparatus of claim 15 further comprising:
a first dropper configured to dispense fertilizer to the first crop row; and
a second dropper configured to dispense fertilizer to the second crop row.

26. The implement apparatus of claim 15 further comprising:
a dropper coupled to the proximal end portion of the extension member and configured to dispense fertilizer between the first crop row and the second crop row.

27. The implement apparatus of claim 15 further comprising a mounting apparatus attached to the distal end portion of the extension member, and wherein the at least three different ground working elements comprises a hipper configured to direct material perpendicularly away from an axis of travel along the ground surface, the hipper comprising:
a first wheel configured to be mounted to the mounting apparatus at a first toe in angle and a second toe in angle; and
a second wheel configured to be mounted to the mounting apparatus at a third toe in angle and a fourth toe in angle.

28. The implement apparatus of claim 15 further comprising a mounting apparatus attached to the distal end portion of the extension member, and wherein the at least three different ground working elements comprises a bermer configured to direct material perpendicularly towards an axis of travel along the ground surface, the bermer comprising:
a first wheel configured to be mounted to the mounting apparatus at a first toe in angle and a second toe in angle; and
a second wheel configured to be mounted to the mounting apparatus at a third toe in angle and a fourth toe in angle.

29. An implement apparatus couplable to a vehicle configured to traverse a ground surface between a first crop row and a second crop row immediately adjacent to the first crop row, wherein the implement apparatus comprises:
an extension member couplable to the vehicle and extending between a proximal end portion and a distal end portion; and
a roller apparatus coupled to the extension member and configured to engage the ground surface between the first crop row and the second crop row when the vehicle traverses the ground surface, wherein the roller apparatus comprises:
a cylindrical portion defining an outer cylindrical surface and lying along a roller axis configured to rotate as the vehicle traverses the ground surface; and
a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface; and
wherein the extension member is couplable to at least one ground working element configured to engage the ground surface and work the ground surface between the first crop row and the second crop row when the vehicle traverses the ground surface, and wherein the implement apparatus is configured to be positioned between the first crop row and the second crop row.

30. The implement apparatus of claim 29, wherein the at least one ground working element comprises one or more of a crumbler, a hipper, and bermer.

31. The implement apparatus of claim 29, wherein the at least one ground working element comprises a crumbler configured to crumble the ground material.

32. The implement apparatus of claim 29, wherein the at least one ground working element comprises a hipper configured to direct the ground material perpendicularly away from an axis of travel along the ground surface.

33. The implement apparatus of claim 29, wherein the at least one ground working element comprises a bermer configured to direct the ground material perpendicularly towards an axis of travel along the ground surface.

34. The implement apparatus of claim 29, wherein at least one ground working element is configured to engage the ground surface between the first crop row and the second crop row.

35. The implement apparatus of claim 29 further comprising:
mounting apparatus configured to couple the at least one ground working element to the extension member; and
a locking apparatus, wherein the mounting apparatus is configured to engage the locking apparatus to retain the mounting apparatus.

36. The implement apparatus of claim 29, wherein the ground working element comprises:
a mounting apparatus attached to the distal end portion of the extension member;
a first wheel movably coupled to a first bracket, the first bracket configured to be attached to the mounting apparatus in a first position and a second position; and
a second wheel movably coupled to a second bracket, the second bracket configured to be attached to the mounting apparatus in a third position and a fourth position.

37. The implement apparatus of claim 36, wherein when the first bracket is mounted in the first position and the second bracket is mounted in the third position, the ground working element is configured to act as a hipper configured to direct the ground material perpendicularly away from an axis of travel along the ground surface, and when the first bracket is mounted in the second position and the second bracket is mounted in the fourth position, the ground working element is configured to act as a bermer configured to direct the ground material perpendicularly towards the axis of travel along the ground surface.

38. The implement apparatus of claim 29 further comprising:
a first dropper configured to dispense fertilizer to the first crop row; and
a second dropper configured to dispense fertilizer to the second crop row.

39. The implement apparatus of claim 29 further comprising:
a dropper coupled to the proximal end portion of the extension member and configured to dispense fertilizer between the first crop row and the second crop row immediately adjacent to the first crop row.

40. The implement apparatus of claim 29 further comprising a mounting apparatus attached to the distal end portion of the extension member, and wherein the at least one ground working element comprises a hipper configured to direct the ground material perpendicularly away from an axis of travel along the ground surface, the hipper comprising:
a first wheel configured to be mounted to the mounting apparatus at a first toe in angle and a second toe in angle; and
a second wheel configured to be mounted to the mounting apparatus at a third toe in angle and a fourth toe in angle.

41. The implement apparatus of claim 29 further comprising a mounting apparatus attached to the distal end portion of the extension member, and wherein the at least one ground
a first wheel configured to be mounted to the mounting apparatus at a first toe in angle and a second toe in angle; and
a second wheel configured to be mounted to the mounting apparatus at a third toe in angle and a fourth toe in angle.

42. An implement apparatus couplable to a vehicle configured to traverse a ground surface, wherein the implement apparatus comprises:
an extension member couplable to the vehicle and extending between a proximal end portion and a distal end portion;
a roller apparatus rotatably coupled to the extension member and configured to engage the ground surface when the vehicle traverses the ground surface, wherein the roller apparatus comprises:
a cylindrical portion defining an outer cylindrical surface and lying along a roller axis configured to rotate as the vehicle traverses the ground surface; and
a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace a ground material when the roller apparatus is engaged with the ground surface as the vehicle traverses the ground surface; and
a chopping apparatus is coupled to the extension member, wherein the chopping apparatus comprises a plurality of cutting blades adapted to rotate relative to the ground surface and oriented such that each of the cutting blades are perpendicular to a direction the vehicle is traversing along the ground surface.

43. The implement apparatus of claim 42, wherein the chopping apparatus further comprises an attachment portion configured to selectively couple the chopping apparatus to the extension member, the attachment portion comprises:
a mounting portion fixedly coupled to the proximal end portion of the extension member; and
a rotatable portion rotatably coupled to the mounting portion and fixedly coupled to the plurality of cutting blades, wherein each of the plurality of cutting blades extend from the rotatable portion.

44. The implement apparatus of claim 43, wherein each of the plurality of cutting blades extends radially from the rotatable portion, wherein each of the plurality of cutting blades are spaced apart from one another about the rotatable portion between a 45 degree angle to a 75 degree angle.

45. The implement apparatus of claim 43, wherein the chopping apparatus further comprises a cutting axle rotatably coupling the rotatable portion to the mounting portion.

46. The implement apparatus of claim 45, wherein each of the plurality of cutting blades defines a length between a first end and a second end in a direction substantially parallel to the cutting axis, wherein the length is substantially similar to a width defined the rotatable portion in a direction substantially parallel to the cutting axis.

47. The implement apparatus of claim 42, wherein the chopping apparatus is moveable between a working configuration and a storage configuration, wherein the plurality of cutting blades, when in the working configuration, are positioned proximate the ground surface, and the plurality of cutting blades, when in the storage configuration, are further above the ground surface than when in the working configuration.

48. The implement apparatus of claim 47, wherein the plurality of cutting blades, when in the working configuration, are in contact with the ground surface.

49. The implement apparatus of claim 42, wherein the chopping apparatus is positioned forward from the roller apparatus.

50. The implement apparatus of claim 42, wherein the implement apparatus further comprises a second chopping apparatus that is positioned rearward from the roller apparatus.

51. The implement apparatus of claim 42, wherein the chopping apparatus further comprises a cutting blade cover configured to block ground material being dispersed from the plurality of cutting blades in a generally upward direction.

52. The implement apparatus of claim 42, wherein the outer cylindrical surface is configured to engage the ground surface when the cylindrical portion is rolled over the ground surface.

53. The implement apparatus of claim 42, wherein the plurality of ground displacing elements are arranged in at least one row circumferentially extending around the outer cylindrical surface of the cylindrical portion.

54. The implement apparatus of claim 42, wherein at least one ground displacing element of the plurality of ground displacing elements defines a forward edge and a rearward edge opposite the forward edge, wherein each of the forward edge and the rearward edge define the chisel edge.

55. The implement apparatus of claim 42, wherein at least one ground displacing element of the plurality of ground displacing elements defines a forward edge and a rearward edge opposite the forward edge, wherein the rearward edge is curved.

56. The implement apparatus of claim 42, wherein the plurality of ground displacing elements comprises four or more ground displacing elements.

57. The implement apparatus of claim 42, wherein a radius of the cylindrical portion perpendicular to the roller axis extends from the roller axis to the outer cylindrical surface, wherein at least one ground displacing element of the plurality of ground displacing elements extends from the outer cylindrical surface to a distal edge defining an element length, wherein the element length is greater than the radius of the cylindrical portion.

58. (canceled)
